(19) United States
(12) Patent Application Publication
(10) Pub. No.: US 2003/0234766 A1
(43) Pub. Date: Dec. 25, 2003

(54) Virtual image display with virtual keyboard

(76) Inventor: Alfred P. Hildebrand, Palo Alto, CA (US)

Correspondence Address: BAKER BOTTS, LLP, 910 LOUISIANA, HOUSTON, TX, 77002-4995, US

(21) Appl. No.: 09/785,024

(22) Filed: Feb. 15, 2001

(51) Int. Cl. G09G 5/00

(52) U.S. Cl. 345/168

(57) ABSTRACT

A device is provided which comprises a device housing; a virtual image display positioned within the device housing, including a microdisplay which forms a source object and an optical system which magnifies the source object to form a magnified virtual image, the optical system including a viewing optic adjacent a side of the device housing through which a user can view the magnified virtual image; a finger controllable mechanism by which the user can control an operation of the virtual image display; a processor which receives electronic signals from the finger controllable mechanism corresponding to the user's operation of the finger controllable mechanism; and logic performable by the processor, the logic comprising logic for causing a source object to be displayed by the microdisplay, logic for modifying the displayed source object in response to the electronic signals from the finger controllable mechanism, logic for causing the microdisplay to display a keyboard having a plurality of user selectable keys, and logic for displaying a cursor and allowing a user to employ the finger controllable mechanism to control movement of the displayed cursor, wherein when the cursor is positioned within a lateral footprint of the displayed keyboard, the cursor logic limits the positioning of the cursor to being position at one of the user selectable keys displayed on the displayed keyboard.

### BACKGROUND OF THE INVENTION

1. Field of the Invention

The invention generally relates to a device with a virtual image display. More specifically, the invention relates to a device which allows a person to control display of the image with his fingers while viewing a magnified image from a virtual image display.

2. Description of Related Art

A continuing objective in the field of electronics is the miniaturization of electronic devices. Most electronic devices include some form of display system which provides information to the person using the device. As electronic devices are reduced in size, display systems are needed which can be incorporated into the increasingly smaller devices. It is thus important that the space required to house these display systems be reduced.

A further objective in the field of electronics is the transformation of electronic devices which are not portable into portable devices. Laptop computers, personal data assistants such as the PALM PILOTJ, cellular telephones, and pagers have greatly increased the number of functions which can be performed using a portable device. However, each of these devices have significant limitations including the relatively large size of laptop computers and the limited amount of information which the displays used in personal assistants, phones and pagers can provide. A need thus continues to exist for compact portable devices which effectively simulate the experience of using larger, less portable devices.

Virtual image displays provide virtual images which appear to be large but are formed from a display which occupies a small volume. Examples of virtual image displays include the displays described in U.S. Pat. Nos. 5,625,372, 5,644,323, 5,684,497, and 5,771,124 which are each incorporated herein by reference. A need currently exists to better exploit these devices in the pursuit of effective miniaturized devices.

### SUMMARY OF THE INVENTION

Devices, methods and software are provided according to the present invention which allow a person to control an image created by a display while viewing a magnified virtual image of the displayed image. As used herein, the combination of the display and the magnification optics used to create the magnified virtual image is a virtual image display.

One aspect of the invention relates to devices, methods and software that allow a person to control an image under the visual control of a virtually displayed keyboard.

In one embodiment, a device is provided which comprises a device housing; a virtual image display positioned within the device housing, including a microdisplay which forms a source object and an optical system which magnifies the source object to form a magnified virtual image, the optical system including a viewing optic adjacent a side of the device housing through which a user can view the magnified virtual image; a finger controllable mechanism by which the user can control an operation of the virtual image display; a processor which receives electronic signals from the finger controllable mechanism corresponding to the user's operation of the finger controllable mechanism; and logic performable by the processor, the logic comprising logic for causing a source object to be displayed by the microdisplay, logic for modifying the displayed source object in response to the electronic signals from the finger controllable mechanism, logic for causing the microdisplay to display a keyboard having a plurality of user selectable keys, and logic for displaying a cursor and allowing a user to employ the finger controllable mechanism to control movement of the displayed cursor, wherein when the cursor is positioned within a lateral footprint of the displayed keyboard, the cursor logic limits the positioning of the cursor to being position at one of the user selectable keys displayed on the displayed keyboard.

Optionally according to this embodiment, when the cursor is positioned within a lateral footprint of the displayed keyboard and the cursor logic recognizes the cursor as being positioned at a first user selectable key, when a signal from the finger controllable mechanism causes the cursor logic to move the cursor from the first user selectable key, the cursor logic limits the initial movement of the cursor to one of the group of user selectable keys which borders the first user selectable key.

Also optionally according to this embodiment, a position of the cursor within the lateral footprint of the displayed keyboard is displayed by having a key of the keyboard at which the cursor logic positions the cursor change in appearance as compared to when the cursor is not positioned at that key. The change in appearance of the key may be, for example, a change in the appearance of a border of the key.

Also optionally according to this embodiment, the cursor logic may recognize a discontinuation of the user operating the finger controllable mechanism as an act of selecting the key at which the cursor is positioned at the time that operation of the finger controllable mechanism is discontinued. The finger controllable mechanism may be a touch pad in which case the discontinuation of the operation of the finger controllable mechanism may be a lifting of a finger from the touch pad.

Also optionally according to this embodiment, the viewing optic is positioned adjacent a first side of the display body and the finger controllable mechanism is positioned adjacent a second side of the display body which is opposite the first side of the display body.

Also optionally according to this embodiment, the finger controllable mechanism is a touch pad.

Also optionally according to this embodiment, the viewing optic is positioned adjacent a first side of the display body and the touch pad is positioned adjacent a second side of the display body which is opposite the first side of the display body.

Also optionally according to this embodiment, the touch pad is positioned such that a footprint of the viewing optic overlaps at least a portion of a footprint of the touch pad.

In another embodiment, a device is provided which comprises: a device housing; a virtual image display positioned within the device housing, including a microdisplay which forms a source object and an optical system which magnifies the source object to form a magnified virtual image, the optical system including a viewing optic adjacent a side of the device housing through which a user can view the magnified virtual image; a finger controllable mechanism by which the user can control an operation of the virtual image display; a processor which receives electronic signals from the finger controllable mechanism corresponding to the user's operation of the finger controllable mechanism; and logic performable by the processor, the logic comprising logic for causing a source object to be displayed by the microdisplay, logic for modifying the displayed source object in response to the electronic signals from the finger controllable mechanism, logic for causing the microdisplay to display a keyboard having a plurality of user selectable keys, wherein the displayed keyboard has a layout where a row of keys above a given key and a row of keys below the given key are horizontally offset relative to the given key such that at least two different keys from the row above are positioned above a lateral footprint of the given key and at least two different keys from the row below are positioned below the lateral footprint of the given key.

The displayed keyboard may optionally have a QWERTY keyboard layout or a TPI layout.

Optionally according to this embodiment, when the cursor is positioned within a lateral footprint of the displayed keyboard, the cursor logic limits the positioning of the cursor to being position at one of the user selectable keys displayed on the displayed keyboard.

Also optionally according to this embodiment, when the cursor is positioned within a lateral footprint of the displayed keyboard and the cursor logic recognizes the cursor as being positioned at a first user selectable key, when a signal from the finger controllable mechanism causes the cursor logic to move the cursor from the first user selectable key, the cursor logic limits the initial movement of the cursor to one of the group of user selectable keys which borders the first user selectable key.

Also optionally according to this embodiment, a position of the cursor within the lateral footprint of the displayed keyboard is displayed by having a key of the keyboard at which the cursor logic positions the cursor change in appearance as compared to when the cursor is not positioned at that key. The change in appearance of the key may be, for example, a change in the appearance of a border of the key.

Also optionally according to this embodiment, the cursor logic may recognize a discontinuation of the user operating the finger controllable mechanism as an act of selecting the key at which the cursor is positioned at the time that operation of the finger controllable mechanism is discontinued.

When the finger controllable mechanism is a touch pad, the discontinuation of the operation of the finger controllable mechanism may be a lifting of a finger from the touch pad.

In yet another embodiment, a device is provided which comprises: a device housing; a virtual image display positioned within the device housing, including a microdisplay which forms a source object and an optical system which magnifies the source object to form a magnified virtual image, the optical system including a viewing optic adjacent a side of the device housing through which a user can view the magnified virtual image; a finger controllable mechanism by which the user can control an operation of the virtual image display; a processor which receives electronic signals from the finger controllable mechanism corresponding to the user's operation of the finger controllable mechanism; and logic performable by the processor, the logic comprising logic for causing a source object to be displayed by the microdisplay, logic for modifying the displayed source object in response to the electronic signals from the finger controllable mechanism, logic for causing the microdisplay to display a keyboard having a plurality of user selectable keys, wherein the displayed keyboard has a circular layout where different keys are positioned about a perimeter of the circle. According to this embodiment, the displayed keyboard may optionally have two or more concentric rings of different keys.

Another aspect of the invention relates to devices, methods and software that allow a person to control an image created by a display using a touch pad while viewing a magnified virtual image of the displayed image. The touch pad may be included on a surface of the device. One feature of the invention is that the touch pad may be operated by a person as the person views a magnified virtual image produced by the virtual image display. In one embodiment, the device comprises a virtual image display which includes a display body; an optical system positioned within the body for providing a magnified virtual image of an electronically generated source object, the optical system including a viewing optic through which a user can view the magnified virtual image; and a touch pad coupled to the body by which the user can control an operation of the virtual image display.

The touch pad may control an operation of the virtual image display with the aid of a processor which receives signals from the touch pad regarding the movement of a finger on a surface of the touch pad, and controls the operation of the virtual image display in response. In this regard, various forms of logic may be operatively associated with the processor which cause the virtual image display to perform the various operations performed by the display.

Examples of operations which the user can control using the touch pad include, but are not limited to, movement of a cursor appearing in the source object, altering an appearance of the source object, causing a different source object to be displayed, inputting information into the device, causing the device to save to memory, causing the device to access information from memory, and causing the device to send information from the device to a remote device.

In regard to causing the device to send information from the device to a remote device, a wide variety of forms of information may be sent to a wide variety of remote devices by a wide variety of mechanisms. For example, information may be sent by a wired connection or a wireless connection to another device. The other device may be a personal computer, a server, a printer, a facsimile machine, an Internet portal, etc. The information may constitute part of a document, an E-mail, a facsimile or a message to a pager.

In regard to altering an appearance of the source object, examples include adding text to the source object, removing text from the source object, adding a symbol to the source object, removing a symbol from the source object, adding an icon to the source object indicating a finger movement, highlighting all or a portion of the source object, changing a font of all or a portion of the source object, changing a font size of all or a portion of the source object, and changing a color of all or a portion of the source object.

In one variation, the touch pad is coupled to the body adjacent a side of the body which is opposite a side of the body which includes the viewing optic. Further according to this variation, the touch pad is preferably positioned opposite the viewing optic such that a footprint of the viewing optic overlaps at least a portion of a footprint of the touch pad. Further according to this variation, in regard to an operation of a cursor appearing in the source object using the touch pad, movement of a finger from left to right across a surface of the touch pad causes the cursor appearing in the source object to move from left to right. In this regard, the touch pad is facing away from the user when the user is viewing the magnified virtual image through the viewing optic. As a result, the finger tip of the finger moving across the surface of the touch pad is pointing in the direction of the user. As a result, movement of the finger tip from left to right (as perceived by the user) across a surface of the touch pad would be seen by the user as coinciding with the direction of the movement of the cursor seen by the user. Meanwhile, the path of the finger tip on the touch pad as perceived by someone viewing the touch pad directly is the left to right mirror image of the path of the cursor on the source image.

It should be noted that such positioning of the touch pad may be utilized for incorporating a touch pad or other finger controllable mechanisms into other image display devices beyond what is disclosed herein. These devices according to the present invention can be advantageous by including a touch pad control mechanism. Compared to conventional user control mechanisms such as a mouse or a roller ball, a touch pad is waterproof, more compact, and easier to be incorporated into the miniaturized body of a device for virtual image display. Further, a touch pad on the surface of the device allows a more effective user control by avoiding the problems associated with large or mini joy sticks which may be caught by other objects due to the bulky size constraints of the joy sticks.

Another aspect of the invention relates to devices, methods and software according to the present invention which allow a person to control an image created by a display while viewing a magnified virtual image of the displayed image using a microphone.

In one embodiment, a device is provided which comprises a virtual image display including a microdisplay which forms a source object and an optical system which magnifies the source object to form a magnified virtual image, the optical system including a viewing optic through which a person can view the magnified virtual image; and a microphone for receiving voice information from the person, the microphone and viewing optic being positioned relative to one another such that the magnified virtual image can be seen by the person at the same time that voice information is received by the microphone from the person.

In another embodiment, a device is provided which includes a virtual image display including a microdisplay which forms a source object and an optical system which magnifies the source object to form a magnified virtual image, the optical system including a viewing optic through which a person can view the magnified virtual image; a microphone for receiving voice information from the person, the microphone including circuitry which converts the voice information delivered by the person into electronic signals encoding the voice information, the microphone and viewing optic being positioned relative to one another such that the magnified virtual image can be seen by the person at the same time that voice information is received by the microphone from the person; and a processor which receives the electronic signals encoding the voice information, the processor including logic for controlling the source object formed on the microdisplay and logic for modifying the source object in response to the electronic signals.

According to this embodiment, the logic for modifying the source object may modify the source object by performing a function selected from the group consisting of adding text to the source object, removing text from the source object, adding a symbol to the source object, removing a symbol from the source object, adding an icon to the source object indicating a voice annotation, highlighting all or a portion of the source object, changing a font of all or a portion of the source object, changing a font size of all or a portion of the source object, and changing a color of all or a portion of the source object.

According to this embodiment, the logic for controlling the source object may include logic for displaying a cursor in the source object. According to this variation, the device may further include a user controlled mechanism for moving where the cursor is displayed in the source object. The user controlled mechanism for moving where the cursor is displayed in the source object may be a hand-controlled mechanism, an eye-controlled mechanism, or a voice-controlled mechanism. According to this variation, the logic for modifying the source object may use the voice information to modify a portion of the source object adjacent where the cursor is being displayed at the time the voice information is received.

Also according to this embodiment, the processor may further include voice recognition logic for converting the voice information received by the microphone into text. In this variation, the logic for modifying the source object may modify the source object to display the text converted by the voice recognition logic. Also according to this variation, the logic for modifying the source object may modify the source object to display the text with the source object being displayed at the time the voice information is received. Also according to this variation, the logic for controlling the source object may include logic for displaying a cursor in the source object. The logic for modifying the source object may modify the source object to display the text adjacent where the cursor is being displayed at the time the voice information is received.

According to this embodiment, the device may further include memory and the processor may further include logic for saving a file encoding the source object or the modified source object in the memory.

According to this embodiment, the processor may further include logic for transmitting a file encoding the modified source object. The modified source object may be transmitted by wireless signals, in which case the device may further include a wireless transmitter. The modified source object may be transmitted by electromagnetic signals, in which case the device may further include an electromagnetic signal transmitter. The modified source object may also be transmitted by modem, in which case the device may further include a modem. The modified source object may be transmitted by telephony signals, in which case the device may further include a telephone.

According to this embodiment, the logic for controlling the source object may include logic for taking an electronic mail message and displaying the electronic mail message as the source object. According to this variation, the logic for modifying the source object may include logic for forming a response to the electronic mail message using the voice information.

According to this embodiment, the logic for modifying the source object in response to the voice information may include logic for using the voice information to control an application and may also include logic for inputting the voice information into an application. A variety of different applications may also be incorporated into the processor including a word processing application such as MS WORDJ or WORDPERFECTJ, an electronic mail application such as CCMAILJ or QUICKMAILJ, a spreadsheet application such as EXCELJ and a web browser such as NETSCAPE NAVIGATOR.

According to any one of the above embodiments, the logic for modifying the source object may use the voice information to modify the source object being displayed at the time the voice information is received, i.e., the source object is modified shortly after the voice information is received, the time delay depending on processor speed, buffering and other variables.

According to any one of the above embodiments, the center of an aperture in the housing for the microphone may be positioned between about 1 and 5 inches from the center of the viewing optic, more preferably between about 2 and 4 inches.

Also according to any one of the above embodiments, the device includes a housing sized to be held in a single hand of a person adjacent a face of the person, the microphone and virtual image display being incorporated into the housing. An aperture for the microphone may be positioned on a same surface of the housing as the viewing optic. According to this variation, the housing may have a length between about 2 and 8 inches, more preferably between about 3 and 6 inches, a width between about 1 and 4 inches, and/or a thickness between about 0.5 and 2 inches, more preferably between about 1 and 1.5 inches.

A variety of methods are also provided according to the present invention. In one embodiment, a method is provided which includes positioning a virtual image display adjacent a person such that the person is viewing a magnified virtual image, the virtual image display including a microdisplay which is forming a source object and an optical system which is magnifying the source object to form the magnified virtual image; positioning a microphone adjacent the person while the person is viewing the magnified virtual image; transmitting voice information from the person to the microphone while the person is viewing the magnified virtual image; and modifying the source object displayed at the time the voice information is received by the microphone using the voice information.

According to this embodiment, a cursor may be displayed in the source object, the method further including moving the cursor to a selected location in the source object prior to transmitting voice information. Modifying the source object may further include modifying the source object adjacent the cursor.

Also according to this embodiment, the method may further include converting the voice information into text wherein modifying the source object includes displaying the text adjacent the cursor.

In another embodiment, a method is provided for corresponding via electronic mail in which the method includes positioning a virtual image display adjacent a person such that the person is viewing a magnified virtual image of an electronic mail message, the virtual image display including a microdisplay which is forming the electronic mail message as a source object and an optical system which is magnifying the source object to form the magnified virtual image of the electronic mail message; positioning a microphone adjacent the person while the person is viewing the magnified virtual image; transmitting voice information from the person to the microphone while the person is viewing the magnified virtual image of the electronic mail message; preparing a response to the electronic mail message using the voice information; and sending the electronic mail message response.

According to this embodiment, preparing a response to the electronic mail message may include adding text to the electronic mail message, removing text from the electronic mail message, adding a symbol to the electronic mail message, removing a symbol from the electronic mail message, adding an icon to the electronic mail message indicating that a voice annotation is attached, highlighting all or a portion of the electronic mail message, changing a font of all or a portion of the electronic mail message, changing a font size of all or a portion of the electronic mail message, and/or changing a color of all or a portion of the electronic mail message.

Also according to this embodiment, a cursor may be displayed in the source object, the method further including moving the cursor to a selected location in the source object prior to transmitting voice information. Preparing a response to the electronic mail message may also include modifying the source object adjacent the cursor using the voice information. The method may further include converting the voice information into text, modifying the source object including displaying the text adjacent the cursor.

Also according to this embodiment, the method may further include saving the electronic mail message response.

Also according to this embodiment, sending the electronic mail message response may be performed by transmitting the electronic mail message response by wireless signals, by electromagnetic signals, by modem and/or by telephony signals.

In another embodiment, a method is provided which includes positioning a virtual image display adjacent a person such that the person is viewing a magnified virtual image of an output of an application, the virtual image display including a microdisplay which is forming the output of the application as a source object and an optical system which is magnifying the source object to form the magnified virtual image of the output of the application; positioning a microphone adjacent the person while the person is viewing the magnified virtual image; inputting voice information from the person into the application through the microphone while the person is viewing the magnified virtual image; and modifying the output of the application in response to the voice information.

According to this embodiment, the voice information may include voice instructions for controlling the application. Also according to this embodiment, the voice information may be data, such as text or numbers for the application. A wide variety of applications may be used including word processing applications such as MS WORDJ or WORDPERFECTJ, electronic mail applications such as CCMAILJ or QUICKMAILJ, spreadsheet applications such as EXCELJ and web browsers such as NETSCAPE NAVIGATOR. The output of the application may be modified as the voice information is inputted.

According to any one of the above methods, the microphone may be positioned between about 1 and 5 inches from the viewing optic, more preferably between about 2 and 4 inches.

Also according to any of the above methods, the microphone and virtual image display may incorporated into a housing sized to be held in a single hand of a person adjacent a face of the person. In such instances, an aperture for the microphone may be positioned on a same surface of the housing as the viewing optic. The housing may have a length between about 2 and 8 inches, more preferably between about 3 and 6 inches, a width between about 1 and 4 inches, and/or a thickness between about 0.5 and 2 inches, more preferably between about 1 and 1.5 inches. Also according to any of the above methods, modifying the source object may include adding text to the source object, removing text from the source object, adding a symbol to the source object, removing a symbol from the source object, adding an icon to the source object indicating a voice annotation, highlighting all or a portion of the source object, changing a font of all or a portion of the source object, changing a font size of all or a portion of the source object, and/or changing a color of all or a portion of the source object.

According to any one of the above embodiments, the virtual image display may be designed to provide a full field of view of the virtual image when the display is positioned between about the surface of the eye of the person and four inches from the eye. The optical system of the virtual image display may be designed to magnify the source object by between about 3× and 15×. The microdisplay may also form a source object having an area between about 10 mm² and 200 mm². The microdisplay may also include pixels having a size between about 7 microns and 20 microns. The viewing optic may also have an optical surface having an area between about 40 mm² and 800 mm².

### BRIEF DESCRIPTION OF THE DRAWINGS

FIG. 1A illustrates an embodiment of a device according to the present invention.

FIG. 1B illustrates an alternate embodiment of a device according to the present invention in which the microphone is not included within the housing of the device.

FIG. 1C illustrates a side view of the housing where the housing has a rectangular shape.

FIG. 1D illustrates a side view of the housing where the housing is shaped such that the microphone aperture is displaced forward relative to the viewing optic of the virtual image display.

FIG. 1E illustrates an embodiment of a device according to the present invention that includes a touch pad coupled to the body adjacent a side of the body which includes the viewing optic.

FIG. 1F illustrates an embodiment of a device according to the present invention that includes a touch pad coupled to the body and positioned opposite the viewing optic.

FIG. 1G illustrates a side view of the device in FIG. 1F.

FIG. 1H illustrates a user moving his finger on the touch pad positioned opposite the viewing optic to control the movement of a cursor.

FIG. 1I illustrates a front view through the viewing optic as the user moves his finger on the touch pad as shown in FIG. 1H, the movement of his finger coincides with the direction of the movement of the cursor seen by the user.

FIG. 1J illustrates a user moving his finger on the touch pad positioned opposite the viewing optic to draw a reversed character “P”.

FIG. 1K illustrates a front view through the viewing optic as the user moves his finger on the touch pad to draw a reversed character “P” as shown in FIG. 1J, the movement of his finger coincides with the direction of the movement of the cursor tracing a character “P” seen by the user.

FIG. 1L illustrates an embodiment of a keyboard layout which may be displayed by and thus used in combination with a virtual image display device.

FIG. 1M illustrates an alternate embodiment of a keyboard layout which may be displayed by and thus used in combination with a virtual image display device.

FIG. 1N illustrates a portion of a keyboard with seven keys.

FIG. 1O illustrates how one navigates a virtually displayed keyboard in conjunction with the above described cursor driver logic.

FIG. 1P illustrates an advantage of using a virtually displayed keyboard as opposed to an actual keyboard.

FIG. 2 illustrates the ability of a person to position the microphone and viewing optic relative to one another such that the magnified virtual image formed by the virtual image display can be seen by the person at the same time that voice information is received by the microphone from the person.

FIG. 3 is a schematic diagram of the various components employed in the device.

FIG. 4 illustrates a virtual image display which includes a microdisplay which forms a source object and an optical system which magnifies the source object to form a magnified virtual image.

FIGS. 5A-5D illustrates an embodiment of a method according to the present invention.

FIG. 5A illustrates a source object that is being viewed by the person as a magnified virtual image.

FIG. 5B illustrates the cursor being moved to a selected position in the source object.

FIG. 5C illustrates the source object being modified to include an icon which symbolizes that a voice annotation has been placed there.

FIG. 5D illustrates the source object being modified to include a text form of the voice information.

### DESCRIPTION OF THE PREFERRED EMBODIMENTS

The present invention relates to the use of virtual image displays in combination with one or more user-controllable mechanisms to control the image display while viewing a magnified image from a virtual image display. The invention also relates to software (also referred to herein as executable logic) which may be used in combination with virtual image displays and the user-controllable mechanisms to control the operation of the displays. Methods are also provided with regard to how the software operates and how users may employ the devices and software of the present invention.

One aspect of the present invention relates to a device including a microphone such that it is possible for a person to provide voice information while simultaneously viewing a magnified virtual image displayed by the virtual image display.

Another aspect of the present invention relates to a device that includes a touch pad which facilitates a person using the device to control the device, and optionally input information into the device, while simultaneously viewing a magnified virtual image displayed by the virtual image display.

Yet another aspect of the present invention relates to a device that includes executable logic for displaying a keyboard as a virtual image, as well as logic for facilitating the navigation of the virtually displayed keyboard and the input of information via the virtually displayed keyboard. The software may be used with any user-controllable mechanisms for controlling the image display, most preferably a touch pad.

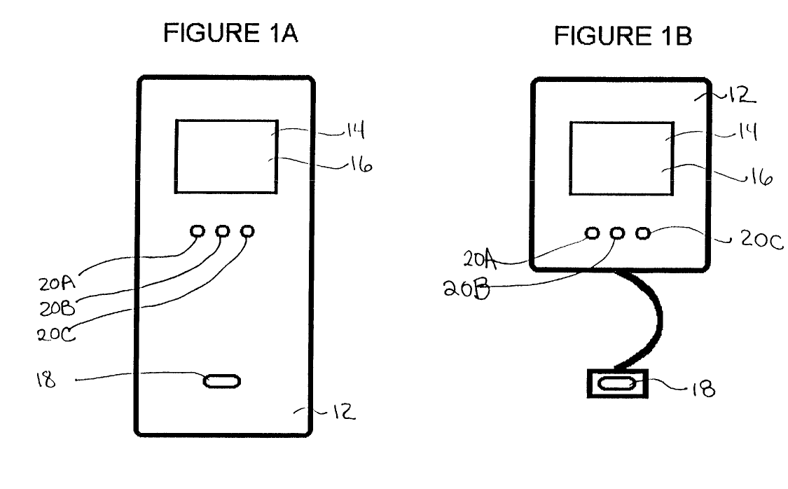

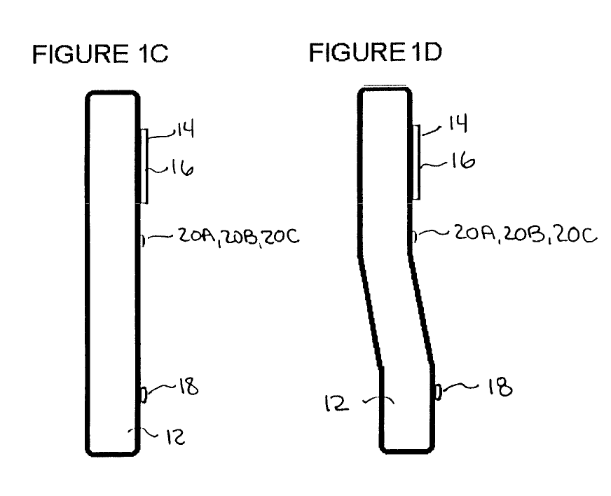

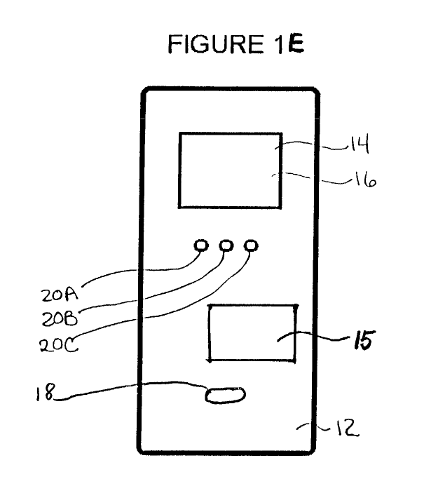

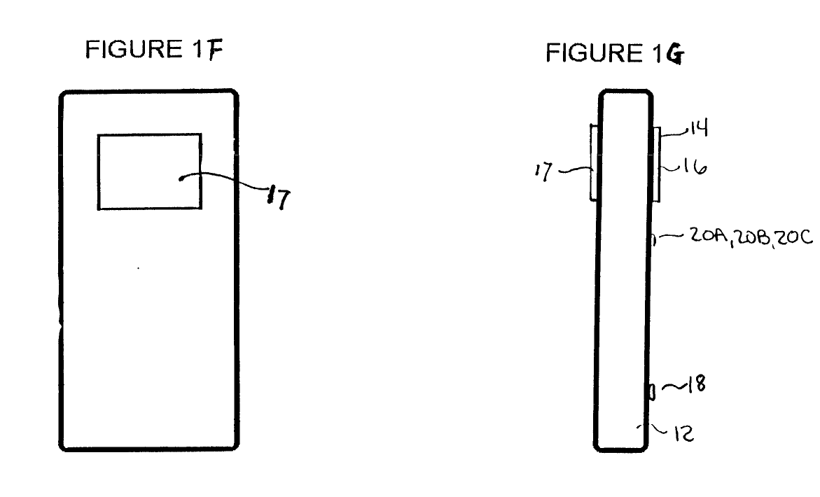

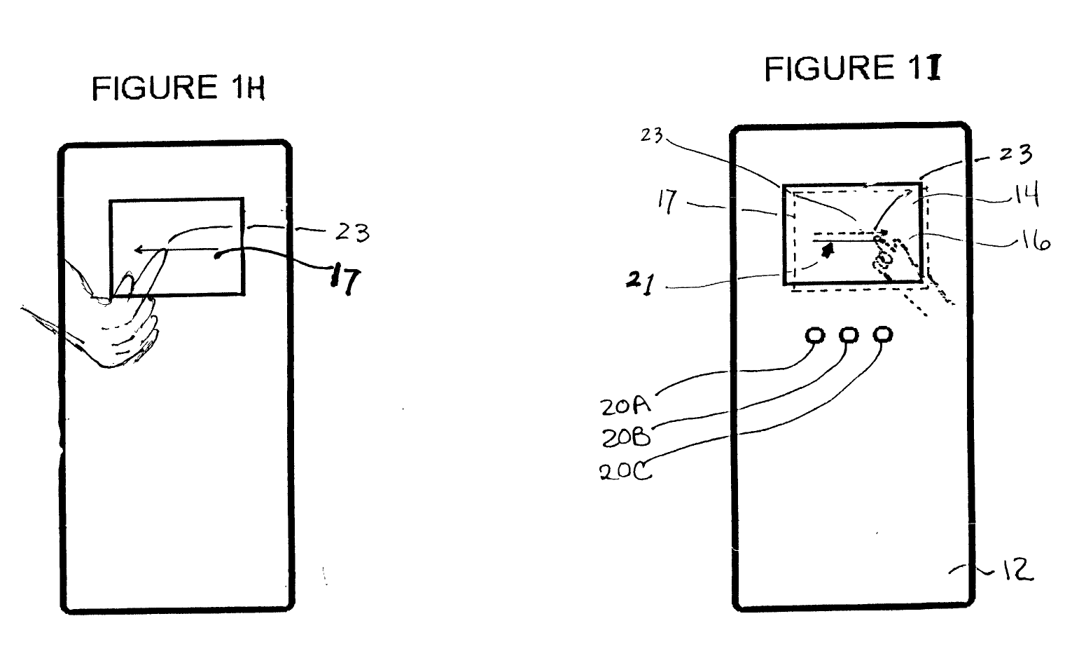

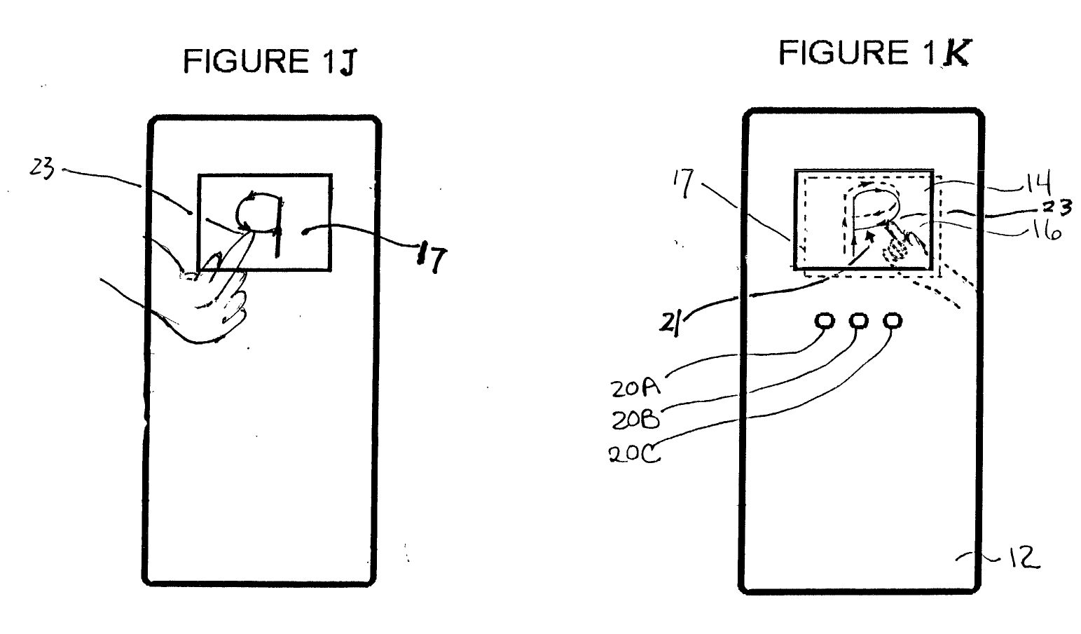

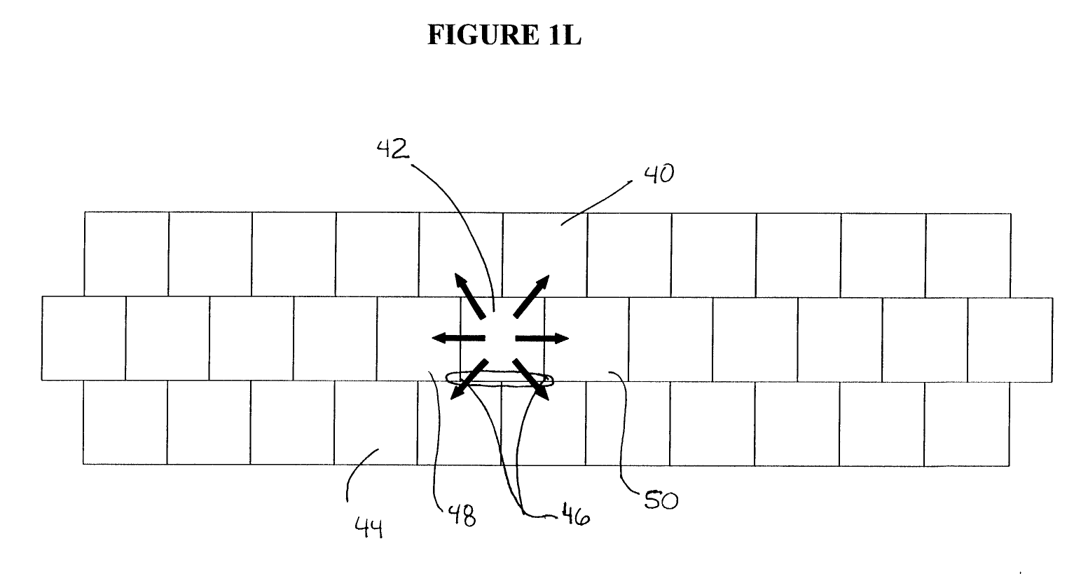

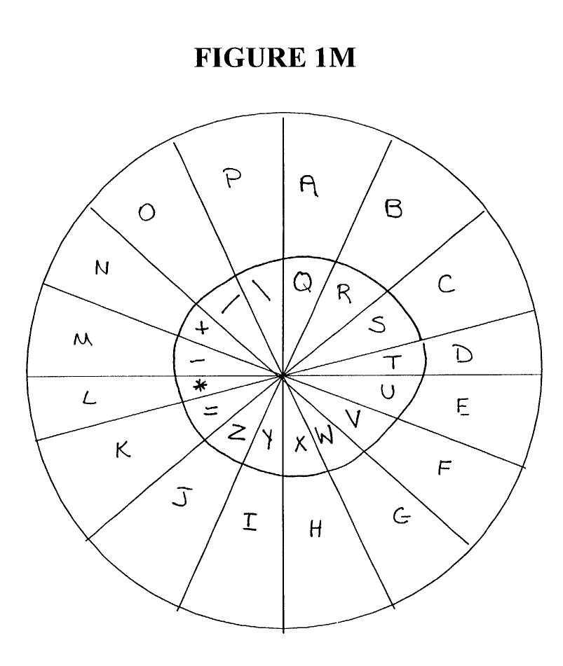

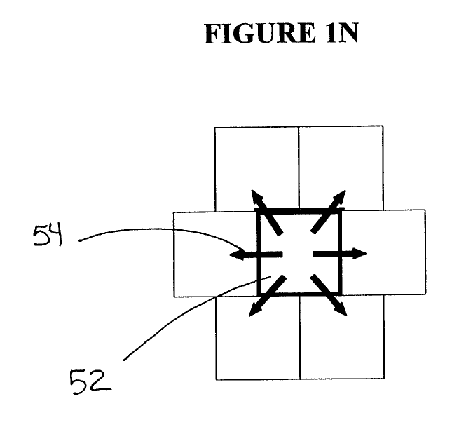

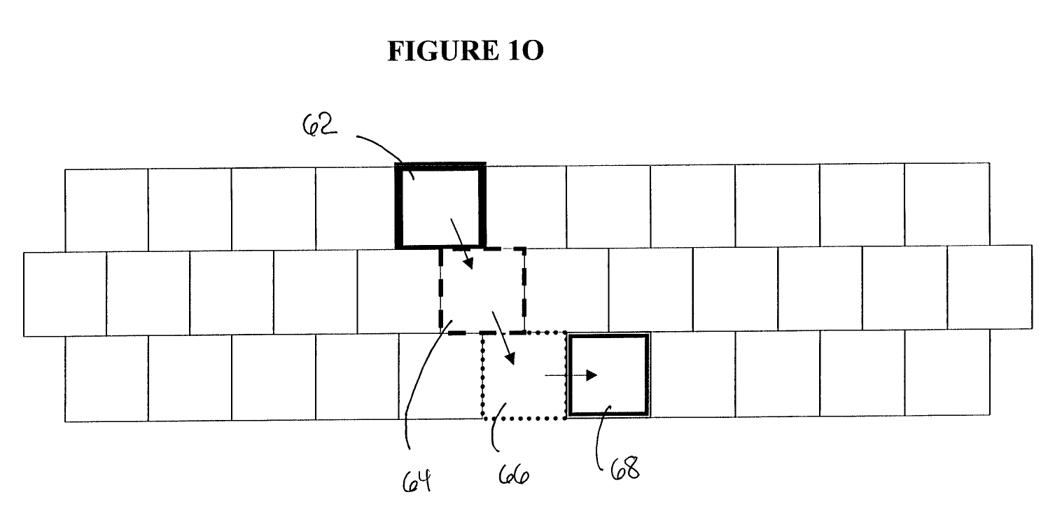

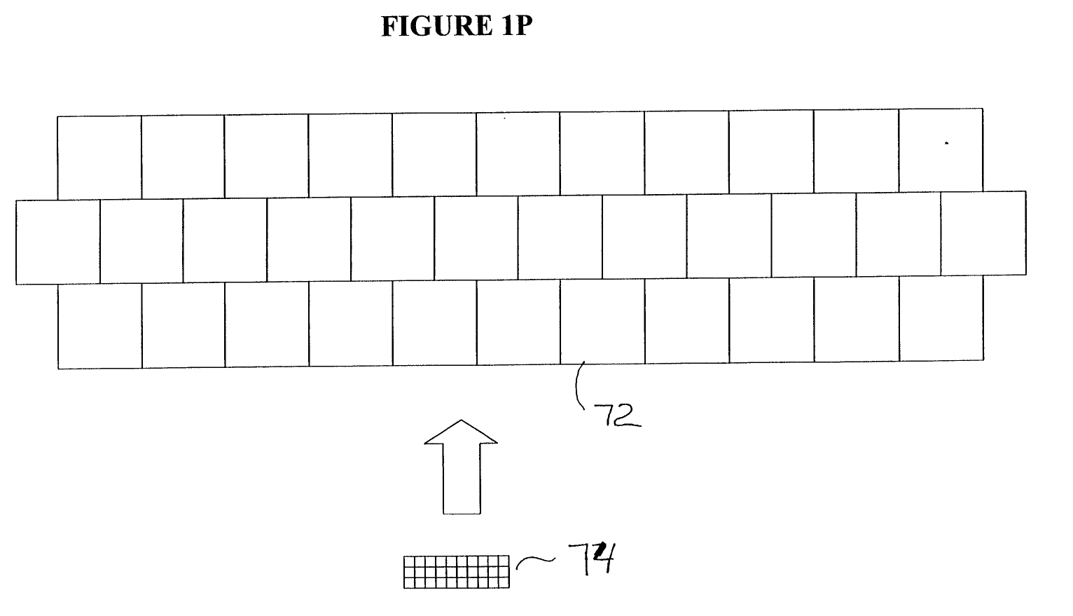

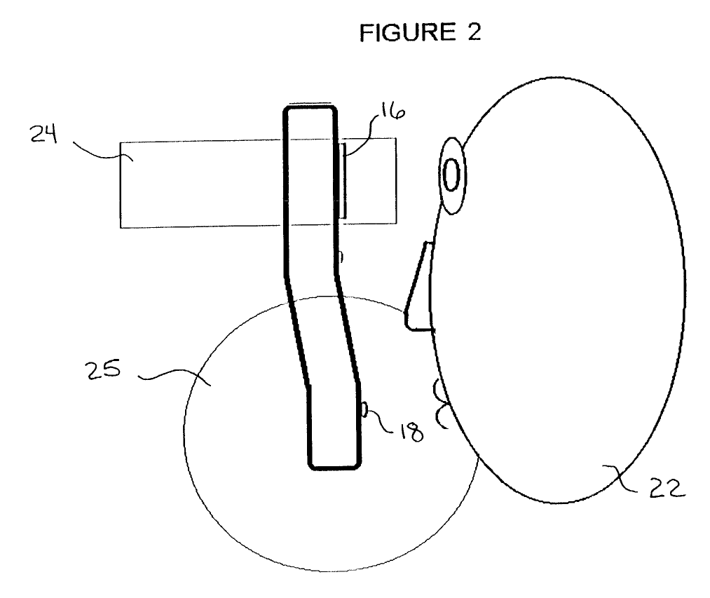

FIG. 1A illustrates an embodiment of a device according to the present invention. As illustrated, the device includes a housing 12 which includes a virtual image display 14. The housing is preferably sized to be held in a single hand of a person adjacent a face of the person. The housing may have a length between about 2 and 8 inches, more preferably between about 3 and 6 inches, a width between about 1 and 4 inches, and/or a thickness between about 0.5 and 2 inches, more preferably between about 1 and 1.5 inches.

Although it is preferred that the device have these dimensions so that the device is adapted to be held in a single hand of a person adjacent a face of the person, it is noted that the software and methods of the present invention may be employed with alternative sized virtual image devices.

Positioned on a surface of the housing 12 is a viewing optic 16 of the virtual image display 14 through which a person views a magnified virtual image of a source object produced by a microdisplay. It is noted that only the viewing optic of the virtual image display 14 is typically visible from outside the device.

Optionally, a microphone 18 may be included in the device for receiving voice information from a person. In one embodiment, the device is a phone which has both speaker and receiver microphones. As illustrated, the microphone 18, or an aperture leading to the microphone, is preferably positioned on a same surface of the housing 12 as the viewing optic 14. However, it is noted that the microphone 18 or an aperture leading to the microphone may be placed on other locations on the device or may be separate from the device so long as the microphone 18 is positionable to receive voice information from a person while the person is viewing a magnified virtual image produced by the virtual image display.

Also included on the device are input devices 20A, 20B, 20C (shown as buttons) which can be used to perform various functions which it may be desirable for the device to perform. At least one of these buttons preferably provides the ability to navigate a cursor generated by software employed with the device. Alternatively, the device may employ a touch pad or another form of user control mechanism which is known in the art to navigate a cursor.

FIG. 1B illustrates an alternate embodiment of a device according to the present invention in which the microphone 18 is not included within the housing 12 of the device. It is noted that the microphone may be wireless.

FIGS. 1C and 1D illustrate side views of the housing. As illustrated in FIG. 1C, the housing may optionally have a rectangular shape. As illustrated in FIG. 1D, the housing may optionally be shaped such that the bottom portion of the housing, adjacent where the microphone 18 is positioned, is displaced forward relative to the viewing optic 14 of the virtual image display. As a result, when the device is positioned adjacent a face of the person, the microphone 18 is closer to the person's face than the viewing optic 14 of the virtual image display. By shaping the housing 12 in this manner, greater eye relief is provided to the person viewing the magnified virtual image while reducing the distance that the microphone needs to be moved away from the person.

Another aspect of the present invention relates to a device including a finger controllable mechanism, such as a touch pad, so that a person can use the touch pad to control the image display as the person views a magnified virtual image produced by the virtual image display.

In one embodiment, the device comprises a virtual image display which includes a display body; an optical system positioned within the body for providing a magnified virtual image of an electronically generated source object, the optical system including a viewing optic through which a user can view the magnified virtual image; and a touch pad coupled to the body by which the user can control an operation of the virtual image display.

FIG. 1E illustrates a variation of the embodiment. The device 12 includes a virtual image display 14 and a touch pad 15 adjacent a side of the body which includes the viewing optic 16. The touch pad 15 allows a person to control an operation of the virtual image display while viewing a magnified image from the virtual image display 14.

FIG. 1F illustrates another variation of the embodiment. The device 12 includes a virtual image display 14 and a touch pad 17 positioned opposite the side of the body which includes the viewing optic 16. In this regard, the touch pad 17 is facing away from the user when the user operates on the touch pad to control the image display while viewing a magnified image from the virtual image display 14.

According to this variation, the touch pad 17 is preferably positioned opposite the viewing optic 16 such that a footprint (e.g., the outer border) of the viewing optic overlaps at least a portion of a footprint of the touch pad 17. FIG. 1G illustrates a side view of the device of this preferred embodiment. As can be seen in the figure, the footprints of the viewing optic and touch pad overlap.

The touch pad may control an operation of the virtual image display with the aid of a processor which receives signals from the touch pad regarding the movement of a finger on a surface of the touch pad, and controls the operation of the virtual image display in response. In this regard, various forms of logic may be operatively associated with the processor which causes the virtual image display to perform the various operations performed by the display.

Examples of operations which the user can control using the touch pad include, but are not limited to, movement of a cursor appearing in the source object, altering an appearance of the source object, causing a different source object to be displayed, inputting information into the device, causing the device to save to memory, causing the device to access information from memory, and causing the device to send information from the device to a remote device.

FIGS. 1H-1K illustrate examples of operations of a cursor appearing in a source object of a virtual image display using a touch pad that is positioned opposite the viewing optic.

As illustrated in FIG. 1H, a user employs a finger on a hand used to hold the device to touch the touch pad 17 positioned opposite the viewing optic while looking through the viewing optic. Seen from the side opposite the viewing optic, the user moves his finger tip 23 on the surface of the touch pad 17 from right to left.

Such a movement illustrated in FIG. 1H causes a cursor appearing in the source object to move in a reversed direction relative to the direction of finger movement seen from the side opposite the viewing optic. FIG. 1I illustrates a front view of the cursor movement through the viewing optic. Viewed from the front, the movement of the user's finger tip 23 from left to right across the surface of the touch pad 17 (right to left when viewing the touch pad directly) causes the cursor 21 appearing in the source object to move from left to right. Because the touch pad 17 is facing away from the user when the user is viewing the magnified virtual image through the viewing optic, the finger tip 23 of the finger moving across the surface of the touch pad 17 is pointing in the direction of the user. As a result, movement of the finger tip 23 from left to right relative to the user across a surface of the touch pad is seen by the user as coinciding with the left to right movement of the cursor 21 seen by the user.

In certain applications, a user may draw a character using a touch pad. As illustrated in FIG. 1J, a user draws a character “P” while looking through the viewing optic. Seen from the side opposite the viewing optic, the trace of his finger movement on the surface of the touch pad 17 forms a reversed character “P”.

Similar to what is described for FIG. 1I, such a movement illustrated in FIG. J also causes a cursor appearing in the source object to move in a reversed direction relative to the direction of finger movement seen from the side opposite the viewing optic. FIG. 1K illustrates a front view of the cursor movement through the viewing optic. Viewed from the front, the movement of the user's finger tip 23 to draw a character “P” across the surface of the touch pad 17 causes the cursor 21 appearing in the source object to move in a direction forming a character “P”. Since the touch pad 17 is facing away from the user, the movement of the finger tip 23 would be seen by the user as coinciding with the direction of the movement of the cursor 21 tracing a character “P” seen by the user.

It should be noted that such a positioning of the touch pad may be utilized for incorporating a touch pad or other finger controllable mechanisms into other image display devices beyond what is disclosed herein.

A user can operate on the touch pad to move a cursor appearing in the source object so as to cause the device to send information from the device to a remote device. A wide variety of forms of information may be sent to a wide variety of remote devices by a wide variety of mechanisms. For example, information may be sent by a wired connection or a wireless connection to another device. The other device may be a personal computer, a server, a printer, a facsimile machine, an Internet portal, etc. The information may constitute part of a document, an E-mail, a facsimile or a message to a pager.

A user can also operate on the touch pad to alter an appearance of the source object, examples include adding text to the source object, removing text from the source object, adding a symbol to the source object, removing a symbol from the source object, adding an icon to the source object indicating a finger movement, highlighting all or a portion of the source object, changing a font of all or a portion of the source object, changing a font size of all or a portion of the source object, and changing a color of all or a portion of the source object.

By using these devices including a touch pad positioned on a side of the display body facing away from the user, the user is able to control the image display more efficiently. The user can move his finger on the surface of the touch pad without interfering with his view through the viewing optic. Moreover, by incorporating a touch pad into the display body, the device may be made more compact and miniaturized, compared to devices using conventional user control mechanisms such as mice, roller balls, large or mini joy sticks. In addition, a touch pad is waterproof and thus allows many versatile usages and convenient carriage for users in various environments.

A further aspect of the present invention, illustrated with regard to FIGS. 1L-1P, is the utilization of a virtual display of a keyboard to control various operations of the device and to enable the input of data into the device

FIG. 1L illustrates an embodiment of a keyboard layout which may be displayed by and thus used in combination with a virtual image display device such as the one described herein. As illustrated, the virtually displayed keyboard has a layout where the row of keys 40 above a given key 42 and the row of keys 44 below the given key 42 are horizontally offset relative to the given key 42 such that at least 2 different keys from the row above 40 are positioned above the lateral footprint 46 of the given key 42 and at least 2 different keys from the row below 44 are positioned below the lateral footprint 46 of the given key 42. In addition, a key is positioned to the left 48 and to the right 50 of the given key 42.

With regard to the labeling of the keys, the virtually displayed keyboard preferably has a QWERTY keyboard layout. The virtually displayed keyboard may also have a TPI layout.

As indicated by the arrows, a user can readily navigate from the given key 42 to the six keys bordering the given key by directing a cursor east, west, north east, north west, south east or south west. This greatly facilitates navigation of the keyboard by the user.

FIG. 1M illustrates an alternate embodiment of a keyboard layout which may be displayed by and thus used in combination with a virtual image display device. As illustrated, the virtually displayed keyboard has a circular layout where different keys are positioned about the circle. As also illustrated, the keyboard may have multiple concentric rings with different letters, numbers or symbols.

The key layout shown in FIG. 1M has the advantage that one can navigate the keyboard by either moving about a perimeter of the inner or outer rings (e.g., A→B→C→D or Q→R→S→T in the illustrated layout), or by going across the circle (e.g., J→Z→R→B in the illustrated layout).

In one embodiment, the software displaying the keyboard is designed so that the image of a cursor (e.g., an arrow or a blinking vertical line) is not displayed when the cursor is positioned within the footprint of the keyboard. Instead, according to this embodiment, a different motif may used to identify the positioning of the cursor.

One of the disadvantages of standard cursors is that they typically either move using a relative cursor driver or an absolute cursor driver.

Relative cursor drivers move a cursor in an analog fashion in a direct, proportional relationship to the movement of a mouse (or the bending of a flexible cursor nub, or the sliding of a finger over a touch pad). For example, standard mice employ relative cursor drivers where there is a ratio between the distance one drags a mouse and the movement of a cursor on a display.

Absolute cursor drivers are sometimes used with touch pads to move a cursor on a display to a position that correlates to a position on which the touch pad is touched. In this regard, the touch pad correlates to a scaled down depiction of the screen. When one touches a touch pad at a position that is 75% across the touch pad (left to right) in the horizontal direction and 75% up the touch pad in the vertical direction (bottom to top), the cursor is moved to a point on the display that is 75% across the display in the horizontal direction (left to right) and 75% up the display (bottom to top) in the vertical direction.

By contrast to these two different cursor driver approaches, the present invention preferably uses a cursor driver approach in conjunction with the virtually displayed keyboard where the cursor may only be positioned at discrete points corresponding to the limit number of keys displayed. In this regard, the logic which controls operation of a cursor does not recognize the cursor as being positioned between keys or off center relative to a given key. Instead, the cursor driver logic determines which single key to associate the cursor with at any given time.

To help to further explain this feature and its operation, FIG. 1N illustrates a portion of a keyboard with seven keys. A bolded border surrounds a certain key 52 and is used to indicate that the logic associated with the device is associating the cursor with that discrete key. The arrows 54 indicate the different directions that the cursor can move, that being, to one of the six keys bordering key 52 at which the cursor is then currently positioned. It is noted that different key layouts, such as the one shown in FIG. 1M, may be used where different numbers of keys border a given key.

Through the use of some form of finger controllable mechanism, such as a touch pad, the user can indicate a direction for moving the cursor. The user may optionally also indicate a magnitude in addition to a direction for moving the cursor.

Since the cursor can only to one of the discrete keys bordering key 52, the cursor driver logic recognizes an instruction from the user via the finger controllable mechanism to move to one of the bordering keys, in this case, one of six directions indicated by arrows 54. Thus, when a user employs the finger controllable mechanism, the cursor driver logic determines which move to a bordering key best matches the input. More precise positioning between keys, on edges of keys, etc. is unnecessary.

FIG. 1O illustrates how one navigates a virtually displayed keyboard in conjunction with the above described cursor driver logic. As illustrated by the arrows, one moves from key 62 to key 68 by sequentially moving to key 64 and then to key 66 and then to key 68. As the cursor moves key to key, each key is optionally highlighted in some manner to indicate the position of the cursor, indicated in the figure as different boldings of the border of the key. Of course, different highlighting schemes may be employed.

The cursor driver logic monitors inputs to the finger controllable mechanism to determine when the cursor is at key 62 that the user wants the cursor to go to key 64. Once at key 64, the cursor driver logic determines from the input to the finger controllable mechanism that the user wants the cursor to go to key 66. Once at key 66, the cursor driver logic determines from the input to the finger controllable mechanism that the user wants the cursor to go to key 68.

Since the cursor driver logic can only move the cursor to discrete keys, the cursor driver logic only needs to determine that the user wishes the cursor to go to a next key. Once the cursor driver logic determines that the user wishes the cursor to go to the next key, the cursor driver logic assumes the cursor is at the next key and looks to the user for further instructions.

By not allowing the cursor to be positioned at any position on the display within the footprint of the keyboard but rather be associated with one of the keys, the cursor driver logic can very readily move the cursor key to key to key. Meanwhile, the user does not have to finely position the cursor at a given key, as one would have to with either an absolute or relative cursor driver scheme. This makes navigation of the virtually displayed keyboard easier to perform.

Many different algorithms can be designed for use with the cursor driver logic according to the present invention where the cursor driver logic only recognizes discrete key positions for positioning the cursor.

One algorithm that may be used involves having the cursor driver logic receive an input from the finger controllable mechanism indicating a direction that the user wishes for the cursor to move, moving that cursor to a bordering key that most closely matches the direction that the user wishes for the cursor to move. The process of monitoring for inputs from the finger controllable mechanism and moving the cursor to bordering keys is continued until a period of time has passed where additional inputs to the finger controllable mechanism have not been received. The timing out of a clock waiting for a next input to the finger controllable mechanism can be used to indicate a selection of a key. In some embodiments, the cursor driver logic can utilize a signal that the user has discontinued contacting the finger controllable mechanism (e.g., the finger is no longer touching the touch pad) to indicate a selection of a key.

Another algorithm that may be used involves having the cursor driver logic receive an input from the finger controllable mechanism indicating a direction that the user wishes for the cursor to move, the input also having a magnitude. In this regard, the input may be viewed as being a vector with both a direction and a magnitude. When the cursor driver logic determines that the vector has more than a predetermined magnitude in a particular direction (e.g., movement of a finger a sufficient length on a touch pad or bending of a cursor nub a sufficient amount and/or for a sufficient period of time), cursor driver logic concludes that the next key in a direction corresponding to the vector has been selected. Different magnitude thresholds may be used to adjust the sensitivity of the finger controllable mechanism and the cursor driver logic. The thresholds may optionally be user adjustable to accommodate different users (e.g., different users may want shorter or longer finger movements on a touch pad to correspond to different key movements). The thresholds may optionally be adjusted by the device itself where the device includes logic which learns from the user his or her style of usage. The thresholds may also optionally be adjusted by the device depending on how the device is being used. For example, when a word processing program is used, a first threshold is employed and when the person is on the phone, a second threshold is employed.

FIG. 1P illustrates an advantage of using a virtually displayed keyboard as opposed to an actual keyboard. Illustrated at the top of the figure is the large virtually displayed keyboard 72. Illustrated at the bottom of the figure is a significantly smaller image of a keyboard 74 that may be displayed by the microdisplay of the virtual image display. It is noted that the size ratio between the virtually displayed keyboard 72 and keyboard 74 displayed by the microdisplay is likely to be large than depicted in the figure.

The size of the virtually displayed keyboard 72 is controlled by the size of the keyboard 74 displayed by the microdisplay and not by the size of the device. Hence, the user is afforded a significantly larger keyboard to interact with when the keyboard is a virtually displayed keyboard 72 than when the keyboard is a real keyboard. By being able to use what visually appears to be a standard sized keyboard, or even an oversized keyboard, the virtual keyboards of the present invention make it easier for users to input information and interact with the device. In addition, different sized keyboards can be used depending on the application (e.g., standard calculators vs. scientific calculators with more function buttons). As a result of enhanced size and size flexibility achieved by using virtually displayed keyboards, small portable devices which incorporate virtually displayed keyboards are more ergonomic to use.

A further aspect of the present invention relates to a device that includes a microphone such that it is possible for a person to provide voice information while simultaneously viewing a magnified virtual image displayed by the virtual image display.

Illustrated in FIG. 2, is a device which allows a person 22 to position the microphone 18 and viewing optic 16 relative to one another such that the magnified virtual image formed by the virtual image display can be seen by the person 22 at the same time that voice information is received by the microphone 18 from the person. In this regard, the microphone 18 is preferably positioned between about 1 and 5 inches from the viewing optic, more preferably between about 2 and 4 inches. Illustrated in FIG. 2 are boxes 24 and 25 within which the viewing optic 16 and microphone 18 respectively may be simultaneously positioned so that the virtual image display can be seen by the person 22 at the same time that voice information is received by the microphone 18 from the person. Greater or shorter distancing between the microphone 18 and viewing optic 16 may be employed depending on the sensitivity of the microphone.

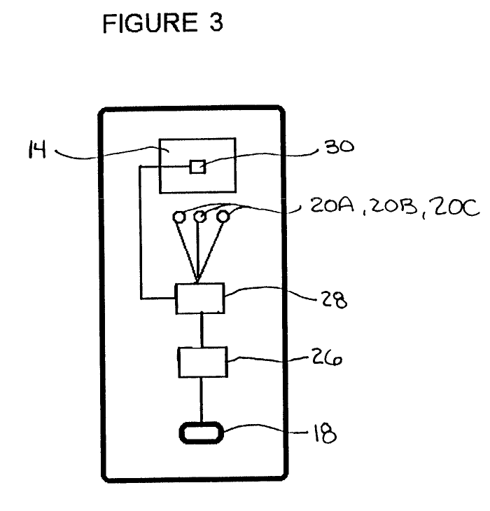

FIG. 3 is a schematic diagram of the various components employed in the device. As illustrated, the microphone 18 includes circuitry 26 which converts voice information delivered by a person into electronic signals encoding the voice information. The electrical signals are conveyed from the circuitry 26 to a processor 28 which controls the operation of the microdisplay 30. Buttons 20A, 20B, 20C or other user operated controls may also be connected to the processor 28 to allow a person operating the device to perform various functions by depressing or moving the buttons.

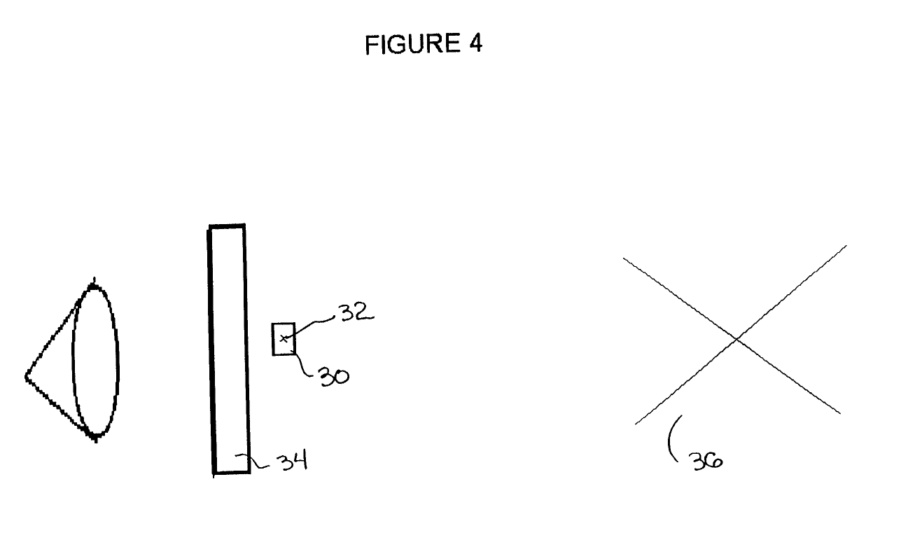

It is noted that any virtual image display may be incorporated in the device which includes a microdisplay. FIG. 4 illustrates a virtual image display which includes a microdisplay 30 which forms a source object 32 and an optical system 34 which magnifies the source object 32 to form a magnified virtual image 36. Examples of virtual image displays that may be used in the device include the displays described in U.S. Pat. Nos. 5,625,372, 5,644,323, 5,684,497, and 5,771,124 which are each incorporated herein by reference.

The virtual image display preferably provides a full field of view of the virtual image when the display is positioned between about the surface of the eye of a person and 4 inches from the eye. The optical system of the virtual image display preferably magnifies the source object by between about 3× and 15×. The microdisplay also preferably forms a source object having an area between about 10 mm² and 200 mm². The viewing optic 16 preferably has an optical surface having an area between about 40 mm² and 80 mm².

Referring back to FIG. 3, a processor 28 is used to control the operation of the microdisplay. In addition, the processor may include logic for performing a variety of functions. For example, the processor may include logic for modifying the source object in response to the voice information. In this regard, when a person speaks into the microphone 18, voice information is inputted into the device. The processor 28 includes logic for causing the source object formed on the microdisplay to change based on the voice information. This, in turn, causes the magnified virtual image seen by the person who is speaking to change.

The voice information may correspond to voice commands. These voice commands may correspond to any command which is commonly used in various known computer applications including electronic mail, word processing, spreadsheet, and web browser applications. Examples of voice commands include open, close, save, next line, previous line, next paragraph, previous paragraph, page up, page down, new message, and send.

The voice information may also correspond to data which is to be added to an application, such as text or numbers.

Examples of modifications to the source object that may occur include adding text to the source object, removing text from the source object, adding a symbol to the source object, removing a symbol from the source object, adding an icon to the source object indicating a voice annotation, highlighting all or a portion of the source object, changing a font of all or a portion of the source object, changing a font size of all or a portion of the source object, and changing a color of all or a portion of the source object.

The processor may further include logic for displaying a cursor in the source object. The device may also include a user controlled mechanism for moving where the cursor is displayed in the source object. The user controlled mechanism for moving where the cursor is displayed in the source object may be a hand-controlled mechanism such as one of the buttons 20A, 20B, 20C or may be touch pad. Alternatively, the device may include an eye position sensor system which enables the observer to use his or her eye to move the cursor. The eye position sensor system may also be used to control a variety of functions performed by the display system. Alternatively, the device may include a voice-controlled mechanism.

One aspect of the present invention is the use of the device to edit documents. In this regard, the logic for modifying the source object may use the voice information to modify a portion of the source object adjacent where the cursor is being displayed at the time the voice information is received. For example, a user may position the sensor and then speak and have voice information contained in the speech be associated with the position of the cursor. In one variation, the voice information may correspond to a digitized version of the speech in which case an icon may appear adjacent where the cursor is positioned indicating that a voice memo is present there. Alternatively, the device may further include voice recognition logic for converting the voice information received by the microphone into text.

In this variation, the logic for modifying the source object may modify the source object to display the text converted by the voice recognition logic.

It is noted that the device may include a variety of additional functionalities. For example, the device may include memory for storing a file encoding the source object or the modified source object and logic for writing the file encoding the source object or modified source object to memory.

The processor may include logic for receiving a file encoding the source object and logic for transmitting a file encoding the modified source object. It is intended that the device may receive and send files by any mechanism known in the art. For example, files encoding source images may be sent and received by wireless signals, in which case the device may include a wireless transmitter. Files encoding source images may be sent and received by electromagnetic signals, in which case the device may include an electromagnetic signal transmitter. Files encoding source images may be sent and received by modem, in which case the device may further include a modem. Files encoding source images may be sent and received by telephony signals, in which case the device may further include a telephone.

In one particular embodiment, the logic for controlling the source object may include logic for taking an electronic mail message and displaying the electronic mail message as the source object. The logic for modifying the source object may include logic for forming a response to the electronic mail message using the voice information. Accordingly, it is intended that the device of the present invention be usable to allow a person to read a magnified virtual image of an electronic mail file and speak into the microphone while viewing the electronic mail file in order to prepare a response.

In another particular embodiment, the logic for modifying the source object in response to the voice information may include logic for using the voice information to control an application. A variety of different applications may also be included in the processor including a word processing application such as MS WORDJ or WORDPERFECTJ, an electronic mail application such as CCMAILJ or QUICKMAILJ, a spreadsheet application such as EXCELJ and a web browser such as NETSCAPE NAVIGATOR. Accordingly, it is intended that the device of the present invention be usable to allow a person to view an application file and while viewing the application file either manipulate the application file using voice commands or add data to the application file by speaking into the microphone.

A variety of methods are also provided according to the present invention. In one embodiment, a method is provided which includes positioning a virtual image display adjacent a person such that the person is viewing a magnified virtual image, as illustrated in FIG. 2. Meanwhile, the microphone is positioned adjacent the person while the person is viewing the magnified virtual image such that voice information can be received by the microphone. Voice information is then transmitted by the person to the microphone while the person is viewing the magnified virtual image. As discussed above, logic in the device operates to use the voice information to modify the source object displayed at the time the voice information is received by the microphone.

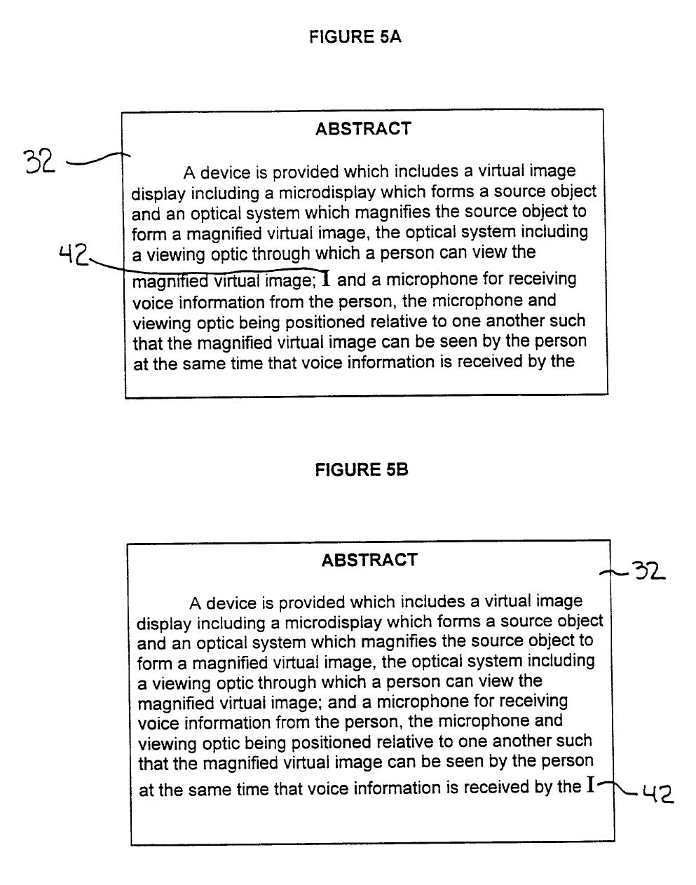

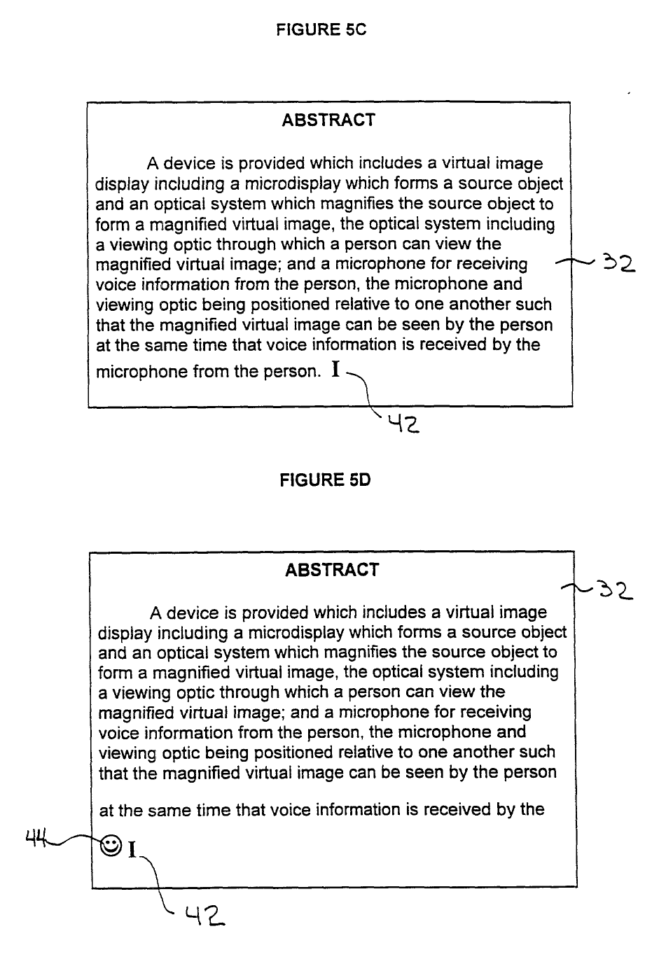

FIGS. 5A-5D illustrates an embodiment of a method according to the present invention. Illustrated in FIG. 5A is the source object being viewed by the person as a magnified virtual image. As illustrated in FIG. 5B, the person moves a cursor 42 to a selected position in the source object 32. The person then speaks into the microphone and, as illustrated in FIG. 5C, the source object is modified adjacent the cursor 42. The modification illustrated in FIG. 5C is a text form of the voice information Alternatively, as illustrated in FIG. 5D, an icon 44 is added to the source object 32 which symbolizes that a voice annotation has been placed there.

The foregoing description of preferred embodiments of the present invention has been provided for the purposes of illustration and description. It is not intended to be exhaustive or to limit the invention to the precise forms disclosed. Obviously, many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

What is claimed is:

1. A device comprising:
a device housing;
a virtual image display positioned within the device housing, including a microdisplay which forms a source object and an optical system which magnifies the source object to form a magnified virtual image, the optical system including a viewing optic adjacent a side of the device housing through which a user can view the magnified virtual image;
a finger controllable mechanism by which the user can control an operation of the virtual image display;
a processor which receives electronic signals from the finger controllable mechanism corresponding to the users operation of the finger controllable mechanism; and
logic performable by the processor, the logic comprising
logic for causing a source object to be displayed by the microdisplay,
logic for modifying the displayed source object in response to the electronic signals from the finger controllable mechanism,
logic for causing the microdisplay to display a keyboard having a plurality of user selectable keys, and
logic for displaying a cursor and allowing a user to employ the finger controllable mechanism to control movement of the displayed cursor, wherein when the cursor is positioned within a lateral footprint of the displayed keyboard, the cursor logic limits the positioning of the cursor to being position at one of the user selectable keys displayed on the displayed keyboard.

2. A device according to claim 1, wherein when the cursor is positioned within a lateral footprint of the displayed keyboard and the cursor logic recognizes the cursor as being positioned at a first user selectable key, when a signal from the finger controllable mechanism causes the cursor logic to move the cursor from the first user selectable key, the cursor logic limits the initial movement of the cursor to one of the group of user selectable keys which borders the first user selectable key.

3. A device according to claim 1, wherein a position of the cursor within the lateral footprint of the displayed keyboard is displayed by having a key of the keyboard at which the cursor logic positions the cursor change in appearance as compared to when the cursor is not positioned at that key.

4. A device according to claim 3, wherein the change in appearance of the key is a change in the appearance of a border of the key.

5. A device according to claim 1, wherein the cursor logic recognizes a discontinuation of the user operating the finger controllable mechanism as an act of selecting the key at which the cursor is positioned at the time that operation of the finger controllable mechanism is discontinued.

6. A device according to claim 5, wherein the finger controllable mechanism is a touch pad and the discontinuation of the operation of the finger controllable mechanism is a lifting of a finger from the touch pad.

7. A device according to claim 1, wherein the viewing optic is positioned adjacent a first side of the display body and the finger controllable mechanism is positioned adjacent a second side of the display body which is opposite the first side of the display body.

8. A device according to claim 1, wherein the finger controllable mechanism is a touch pad.

9. A device according to claim 1, wherein the viewing optic is positioned adjacent a first side of the display body and the touch pad is positioned adjacent a second side of the display body which is opposite the first side of the display body.

10. A device according to claim 1, wherein the touch pad is positioned such that a footprint of the viewing optic overlaps at least a portion of a footprint of the touch pad.

11. A device according to claim 1, wherein the housing has a length between about 2 and 8 inches and a width between about 1 and 4 inches.

12. A device according to claim 1, wherein the housing has a thickness between about 0.5 and 2 inches.

13. A device according to claim 1, wherein the virtual image display provides a full field of view of the virtual image when the display is positioned between about at a surface of the eye of the person and 4 inches from the eye.

14. A device according to claim 1, wherein the optical system of the virtual image display magnifies the source object by between about 3× and 15×.

15. A device according to claim 1, wherein the microdisplay forms a source object having an area between about 10 mm² and 200 mm².

16. A device according to claim 1, wherein the viewing optic has an optical surface having an area between about 40 mm² and 800 mm².

17. A device comprising:
a device housing;
a virtual image display positioned within the device housing, including a microdisplay which forms a source object and an optical system which magnifies the source object to form a magnified virtual image, the optical system including a viewing optic adjacent a side of the device housing through which a user can view the magnified virtual image;
a finger controllable mechanism by which the user can control an operation of the virtual image display;
a processor which receives electronic signals from the finger controllable mechanism corresponding to the user's operation of the finger controllable mechanism; and
logic performable by the processor, the logic comprising
logic for causing a source object to be displayed by the microdisplay,
logic for modifying the displayed source object in response to the electronic signals from the finger controllable mechanism,
logic for causing the microdisplay to display a keyboard having a plurality of user selectable keys, wherein the displayed keyboard has a layout where a row of keys above a given key and a row of keys below the given key are horizontally offset relative to the given key such that at least two different keys from the row above are positioned above a lateral footprint of the given key and at least two different keys from the row below are positioned below the lateral footprint of the given key.

18. A device according to claim 17, wherein the displayed keyboard has a QWERTY keyboard layout.

19. A device according to claim 17, wherein the displayed keyboard has a TPI layout.

20. A device according to claim 17, wherein when the cursor is positioned within a lateral footprint of the displayed keyboard, the cursor logic limits the positioning of the cursor to being position at one of the user selectable keys displayed on the displayed keyboard.

21. A device according to claim 17, wherein when the cursor is positioned within a lateral footprint of the displayed keyboard and the cursor logic recognizes the cursor as being positioned at a first user selectable key, when a signal from the finger controllable mechanism causes the cursor logic to move the cursor from the first user selectable key, the cursor logic limits the initial movement of the cursor to one of the group of user selectable keys which borders the first user selectable key.

22. A device according to claim 17, wherein a position of the cursor within the lateral footprint of the displayed keyboard is displayed by having a key of the keyboard at which the cursor logic positions the cursor change in appearance as compared to when the cursor is not positioned at that key.

23. A device according to claim 22, wherein the change in appearance of the key is a change in the appearance of a border of the key.

24. A device according to claim 17, wherein the cursor logic recognizes a discontinuation of the user operating the finger controllable mechanism as an act of selecting the key at which the cursor is positioned at the time that operation of the finger controllable mechanism is discontinued.

25. A device according to claim 24, wherein the finger controllable mechanism is a touch pad and the discontinuation of the operation of the finger controllable mechanism is a lifting of a finger from the touch pad.

26. A device comprising:
a device housing;
a virtual image display positioned within the device housing, including a microdisplay which forms a source object and an optical system which magnifies the source object to form a magnified virtual image, the optical system including a viewing optic adjacent a side of the device housing through which a user can view the magnified virtual image;
a finger controllable mechanism by which the user can control an operation of the virtual image display;
a processor which receives electronic signals from the finger controllable mechanism corresponding to the user's operation of the finger controllable mechanism; and
logic performable by the processor, the logic comprising
logic for causing a source object to be displayed by the microdisplay,
logic for modifying the displayed source object in response to the electronic signals from the finger controllable mechanism,
logic for causing the microdisplay to display a keyboard having a plurality of user selectable keys, wherein the displayed keyboard has a circular layout where different keys are positioned about a perimeter of the circle.

27. A device according to claim 26, wherein the displayed keyboard has at least two concentric rings of different keys.

28. A device according to claim 26, wherein the cursor logic only allows a cursor to be displayed within a lateral footprint of the displayed keyboard as a selection of one of the keys of the displayed keyboard.
